(19) United States
(12) Patent Application Publication
(10) Pub. No.: US 2010/0316926 A1
(43) Pub. Date: Dec. 16, 2010

(54) FUEL CELL SYSTEM

(75) Inventors: Norimasa Ishikawa, Toyota-shi (JP); Hiroyuki Yumiya, Nagoya-shi (JP); Katsuki Ishigaki, Handa-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/521,369

(22) PCT Filed: Dec. 5, 2007
(86) PCT No.: PCT/JP2007/073891

§ 371 Date: Dec. 3, 2009

(30) Foreign Application Priority Data
Dec. 27, 2006 (JP) 2006-351482

(51) Int. Cl. H01M 8/04

(52) U.S. Cl. 429/444

(57) ABSTRACT

A fuel cell system performs feedback control with respect to a reactive gas supplying apparatus based on a proportional obtained by multiplying a deviation of an actual flow quantity from a target value of a reactive gas supplied to the fuel cell from the reactive gas supplying apparatus by a proportional gain and an integral term obtained by multiplying the deviation by an integration gain to perform time integration in such a manner that the actual flow quantity coincides with the target value, and changes an update arithmetic operation of the integral term in accordance with a value of the deviation.

### TECHNICAL FIELD

The present invention relates to a fuel cell system including a reactive gas supplying apparatus that supplies a reactive gas to a fuel cell.

### BACKGROUND ART

In recent years, as a part of efforts to environmental issues, development of a low-emission vehicle has been advanced, and there is a fuel cell vehicle using a fuel cell as an in-vehicle power supply as one of such vehicles. A fuel cell system is an energy conversion system which supplies a reactive gas to a membrane-electrode assembly having an anode pole arranged on one surface of an electrolytic film and a cathode pole arranged on the other surface to bring about an electrochemical reaction, thereby converting chemical energy into electrical energy. Among others, a polyelectrolyte type fuel cell system that uses a solid polymer film as an electrolyte can be reduced-in size at a low cost and has a high power density, and hence an application as an in-vehicle power source is expected.

As means for highly accurately controlling a flow quantity and a pressure of a fuel gas supplied to a fuel cell, a structure which uses an injector having excellent responsiveness is known as disclosed in, e.g., Japanese Patent Application Laid-open No. 2005-302563.

[Patent Document 1] Japanese Patent Application Laid-open No. 2005-302563

### DISCLOSURE OF THE INVENTION

Meanwhile, in a situation where a fuel cell vehicle is, e.g., rapidly accelerated, since a load on a fuel cell is precipitously increased, an amount of a change in injector secondary pressure instruction value with time is transiently increased. In such a transient state, an injector secondary pressure cannot draw level with the injector secondary pressure instruction value, and a deviation of both the values is temporarily increased. In a system that performs feedback control with respect to gas jetting from an injector based on a proportional-plus-integral action, when a deviation of the injector secondary pressure and the injector secondary pressure instruction value is regarded as a steady-state deviation to carry out an update arithmetic operation of an integral term in such a transient state, a value of the integral term is increased beyond necessity, and hence there arises an inconvenience that the injector secondary pressure is overshot when the injector secondary pressure instruction value is stabilized at a fixed value.

Such a problem is an issue that is common to systems each of which performs feedback control with respect to supply of a reactive gas to a fuel cell from a reactive gas supplying apparatus (e.g., an air compressor or a hydrogen circulating pump) based on a proportional-plus-integral action.

Thus, it is an object of the present invention to suppress erroneous integration of an actual flow quantity and a target value of a reactive gas when a fluctuation in load of a fuel cell is large, thereby reducing an overshoot of a reactive gas supply flow amount.

To achieve this object, a fuel cell system according to the present invention comprises: a reactive gas supplying apparatus which supplies a reactive gas to a fuel cell; a feedback control apparatus which performs feedback control with respect to the reactive gas supplying apparatus based on a proportional obtained by multiplying a deviation of an actual flow quantity from a target value of a reactive gas supplied to the fuel cell from the reactive gas supplying apparatus by a proportional gain and an integral term obtained by multiplying the deviation by an integration gain to perform time integration in such a manner that the actual flow quantity coincides with the target value; and an arithmetic control apparatus which changes an update arithmetic operation of the integral term in accordance with a value of the deviation.

Changing the update arithmetic operation of the integral term based on the deviation of the actual flow quantity and the target value of the reactive gas supplied to the fuel cell enables suppressing erroneous integration of the deviation of the actual flow amount and the target value of the reactive gas when a fluctuation in load of the fuel cell is large, thereby suppressing an overshoot of a reactive gas supply flow quantity.

The reactive gas supplying apparatus is, e.g., an injector which supplies a fuel gas to the fuel cell. The arithmetic control apparatus inhibits the update arithmetic operation of the integral term when the deviation of the actual flow quantity from the target value of the fuel gas is equal to or above a predetermined threshold value.

When the deviation of the actual flow quantity and the target value of the fuel gas is equal to or above the predetermined threshold value, since a fluctuation in load of the fuel cell is increased, inhibiting erroneous integration of the deviation of the actual flow quantity and the target value of the fuel gas in such a case enables suppressing an overshoot of the fuel gas supply flow quantity.

The reactive gas supplying apparatus is, e.g., an air compressor which supplies an oxidizing gas to the fuel cell. The arithmetic control apparatus changes the integration gain to a smaller value when the deviation of the actual flow quantity from the target value of the oxidizing gas is equal to or above a predetermined threshold value.

When the deviation of the actual flow quantity and the target value of the oxidizing gas is equal to or above the predetermined threshold value, since a fluctuation in load of the fuel cell is large, changing the integration gain concerning the air compressor control to a smaller value in such a case enables suppressing an overshoot of an oxidizing gas supply flow quantity.

The fuel cell system may comprise an injector which supplies a fuel gas to the fuel cell and an air compressor which supplies an oxidizing gas to the fuel cell as the reactive gas supplying apparatus. The feedback control apparatus performs feedback control with respect to fuel gas supply using the injector and oxidizing gas supply using the air compressor.

### BRIEF DESCRIPTION OF THE DRAWINGS

FIG. 1 is a system structural view of a fuel cell system according to this embodiment;

FIG. 2 is a functional block diagram of injector control according to this embodiment;

FIG. 3 is a timing chart of FC current values, gas jetting instruction times, injector secondary pressure instruction values, and injector drive cycles;

FIG. 4 is a functional block diagram of air compressor control according to this embodiment; and

FIG. 5 is a graph showing a relationship between an actual flow quantity and a target value of an air compressor.

### BEST MODE FOR CARRYING OUT THE INVENTION

An embodiment according to the present invention will now be described hereinafter with reference to the respective drawings.

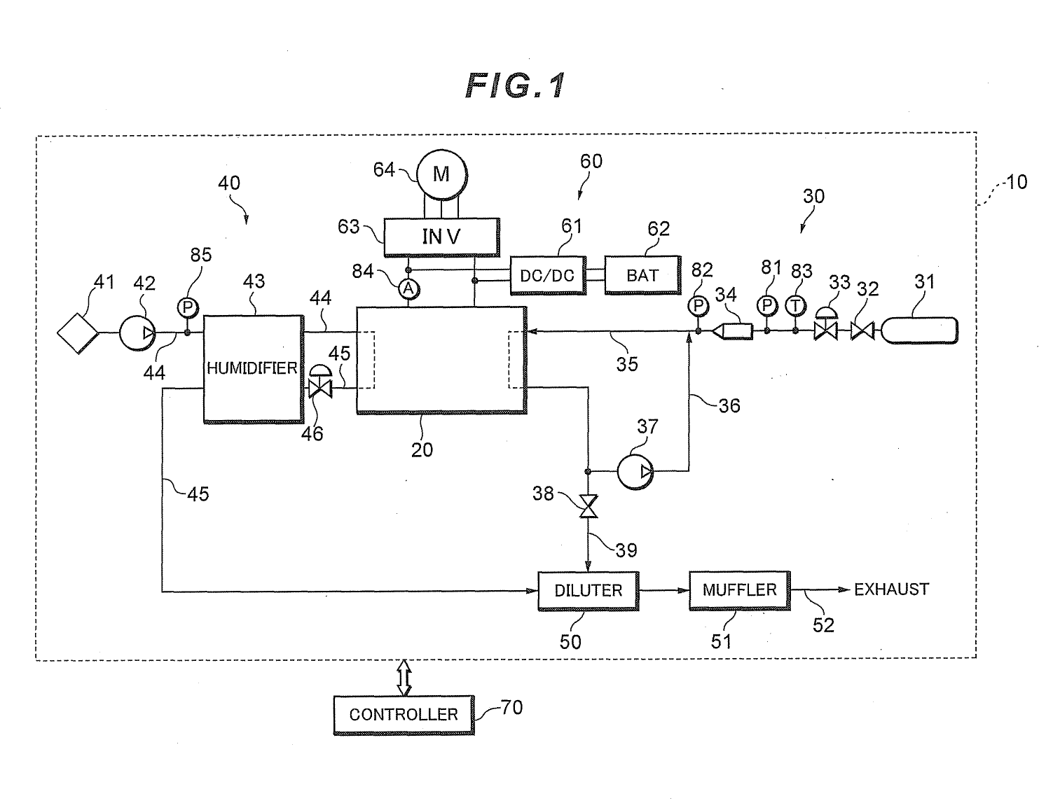

FIG. 1 shows a system configuration of a fuel cell system 10 that functions as an in-vehicle power supply system for a flue cell vehicle.

The fuel cell system 10 includes a fuel battery stack 20 that generates electric power upon receiving supply of a reactive gas (an oxidizing gas and a fuel gas), a fuel gas piping system 30 that supplies a hydrogen gas as the fuel gas to the fuel cell stack 20, an oxidizing gas piping system 40 that supplies air as an oxidizing gas to the fuel cell stack 20, a power system 60 that controls charge/discharge of electric power, and a controller 70 that performs overall control of the entire system.

The fuel cell stack 20 is, e.g., a polyelectrolyte type cell stack obtained by laminating many cells in series. The cell has a cathode pole on one surface of an electrolytic film formed of an ion-exchange membrane and an anode pole on the other surface and has a pair of separators to sandwich the cathode pole and the anode pole from both sides thereof. The fuel gas is supplied to a fuel gas flow path of one separator, the oxidizing gas is supplied to an oxidizing gas flow path of the other separator, and the fuel cell stack 20 generates electric power based on this gas supply.

The fuel gas piping system 30 has a fuel gas supply source 31, a fuel gas supply flow path 35 through which the fuel gas (a hydrogen gas) supplied to the anode pole of the fuel cell stack 20 flows from the fuel gas supply source 31, a circulating flow path 36 that is used to reflux a fuel off-gas (a hydrogen off-gas) discharged from the fuel cell stack 20 to the fuel gas supply flow path 35, a circulating pump 37 that supplies the fuel off-gas in the circulating flow path 36 to the fuel gas supply flow path 35 with a pressure, and an exhaust flow path 39 that is divaricated to be connected with the circulating flow path 36.

The fuel gas supply source 31 is formed of, e.g., a high-pressure hydrogen tank or a hydrogen storing alloy, and stores the hydrogen gas having a high pressure (e.g., 35 MPa or 70 MPa). When a cutoff valve 32 is opened, the hydrogen gas flows out to the fuel gas supply flow path 35 from the fuel gas supply source 31. The hydrogen gas is depressurized to a predetermined pressure (e.g., approximately 200 kPa) by a regulator 33 or an injector 34 and supplied to the fuel cell stack 20.

It is to be noted that the fuel gas supply source 31 may be formed of a reformer that generates a hydrogen rich reformed gas from hydrocarbon-based fuel and a high-pressure gas tank that increases a pressure of the reformed gas generated by the reformer to be accumulated.

The regulator 33 is a device that regulates an upstream-side pressure (a primary pressure) to a preset secondary pressure. In this embodiment, a mechanical pressure reducing valve that reduces the primary pressure is adopted as the regulator 33. As a structure of the mechanical pressure reducing valve, it is possible to adopt a known structure that has a case formed with a back pressure chamber and a pressure regulating chamber apart from each other through a diaphragm and reduces the primary pressure to a predetermined pressure in the pressure regulating chamber by using a back pressure in the back-pressure chamber to provide the secondary pressure.

When the regulator 33 is arranged on the upstream side of the injector 34, the upstream-side pressure of the injector 33 can be effectively reduced. Therefore, a freedom degree of design in a mechanical structure (a valve disc, a case, a flow path, a driver, and others) of the injector 34 can be increased.

Furthermore, since the upstream-side pressure of the injector 34 can be reduced, it is possible to prevent the valve disc of the injector 34 from having difficulty in movement due to an increase in differential pressure between the upstream-side pressure and a downstream-side pressure of the injector 34. Therefore, a variable pressure regulation margin of the downstream-side pressure of the injector 34 can be increased, and a reduction in responsiveness of the injector 34 can be suppressed.

The injector 34 is an electromagnetic driven on-off valve that can adjust a gas flow quantity or a gas pressure by directly driving the valve disc by using an electromagnetic driving force in a predetermined drive cycle to be apart from a valve seat. The injector 34 has a valve disc that opens or closes the fuel gas supply path 35, a valve driving solenoid coil, an armature integrated with the valve disc, and a stator that accommodates the solenoid coil therein, and is configured in such a manner that that the armature is sucked by the stator and the valve disc is moved to a predetermined valve opening position or valve closing position based on energization to the solenoid coil.

In this embodiment, an opening area of a jet orifice of the injector 34 can be switched on two stages in response to ON/OFF of a pulse exciting current that is fed to the solenoid coil. A gas jetting time and a gas jetting timing of the injector 34 are controlled in accordance with a jetting command output from the controller 70, thereby highly accurately controlling a flow quantity and a pressure of the fuel gas. The injector 34 directly drives opening/closing of the valve (the valve disc and the valve seat) by using the electromagnetic driving force and has high responsiveness because its drive cycle can be controlled to a high-response range.

In order to supply a requested gas flow quantity to the downstream side, the injector 34 changes at least one of an opening area (an aperture) and an opening time of the valve disc provided in a gas flow path of the injector 34 to adjust a gas flow quantity (or a hydrogen molarity) supplied to the downstream side (the fuel cell stack 20 side).

It is to be noted that the gas flow quantity is adjusted by opening/closing of the valve disc of the injector 34 and a gas pressure supplied to the downstream side of the injector 34 is reduced to be smaller than a gas pressure on the upstream side of the injector 34, and hence the injector 34 can be interpreted as a pressure regulating valve (a pressure reducing valve or a regulator). Moreover, in this embodiment, the injector 34 can be also interpreted as a variable pressure regulating valve that can change a pressure regulating amount (a pressure reducing amount) of the gas pressure on the upstream side of the injector 34 to be matched with a requested pressure in a predetermined pressure range in accordance with a gas request. The injector 34 functions as a variable gas supplying apparatus that adjusts a gas state (a gas flow quantity, a hydrogen molarity, and a gas pressure) on the upstream side of the fuel gas supply flow path 35 and supplies the gas toward the downstream side.

To the fuel gas supply flow path 35 are disposed a primary-side pressure sensor 81 that detects an upstream-side pressure (a primary pressure) of the injector 34, a primary-side temperature sensor 83 that detects an upstream-side temperature of the injector 34, and a secondary-side pressure sensor 82 that detects a downstream-side pressure (a secondary pressure) of the injector 34, respectively.

The exhaust flow path 39 is connected with the circulating flow path 36 through the exhaust valve 38. The exhaust valve 38 operates in response to an instruction from the controller 70 to discharge the fuel off-gas containing an impurity and moisture in the circulating flow path 36 to the outside. When the exhaust valve 38 is opened, a concentration of the impurity in the fuel off-gas in the circulating flow path 36 is reduced, and a hydrogen concentration in the fuel off-gas that is supplied to be circulated is increased.

The fuel off-gas that is discharged through the exhaust valve 38 and the exhaust flow path 39 and an oxidizing off-gas flowing through a discharge flow path 45 flow into a diluter 50, and the diluter 50 dilutes the fuel off-gas. Discharge sound of the diluted fuel off-gas is muffled by a muffler (a silencer) 51, and the fuel off-gas flows through a tail pipe 52 to be discharged to the outside of a vehicle.

The oxidizing gas piping system 40 has an oxidizing gas supply flow path 44 through which the oxidizing gas supplied to the cathode pole of the fuel cell stack 20 flows and the discharge flow path 45 through which the oxidizing off-gas discharged from the fuel cell stack 20 flows.

To the oxidizing gas supply flow path 44 are provided an air compressor 42 that takes in the oxidizing gas via the filter 41, a pressure sensor 85 that detects a downstream-side pressure (a secondary pressure) of the air compressor 42, and a humidifier 43 that humidifies the oxidizing gas supplied by the pressure from the air compressor 42. A back-pressure regulating valve 46 that regulates an oxidizing gas supplying pressure and the humidifier 43 are provided to the discharge flow path 45.

The humidifier 43 accommodates a water vapor permeation membrane bundle (a hollow fiber membrane bundle) formed of many water vapor permeation membranes. The high-humidity oxidizing off-gas (a wet gas) containing a large amount of moisture generated by a cell reaction flows through the inside of the water vapor permeation membranes and, on the other hand, the low-humidity oxidizing gas (a dry gas) taken in from atmospheric air flows outside the water vapor permeation membranes. When moisture exchange is carried out between the oxidizing gas and the oxidizing off-gas through the water vapor permeation membranes, the oxidizing gas can be humidified.

The power system 60 has a DC/DC converter 61, a battery 62, a traction inverter 63, a traction motor 64, and a current sensor 84.

The DC/DC converter 61 is a direct-current voltage transducer and has a function of boosting a direct-current voltage from the battery 62 to be output to the traction inverter 63 and a function of decreasing a direct-current voltage from the fuel cell stack 20 or the traction motor 64 to charge the battery 62. These functions of the DC/DC converter 61 enable controlling charge/discharge of the battery 62. Further, a driving point (an output voltage or an output current) of the fuel cell stack 20 is controlled based on voltage transducing control by the DC/DC converter 61.

The battery 62 is a storage device which can store and discharge electric power and functions as a regenerative energy storage source at the time of brake regeneration and an energy buffer at the time of a fluctuation in load involved by acceleration or deceleration of a fuel cell vehicle. As the battery 62, a secondary battery, e.g., a nickel-cadmium accumulator battery, a nickel-hydride accumulator battery, or a lithium secondary battery is preferable.

The traction inverter 63 converts a direct current into a three-phase alternating current to be supplied to the traction motor 64. The traction motor 64 is, e.g., a three-phase alternating current motor and constitutes a power source of the fuel cell vehicle. The current sensor 84 detects an output current (an FC current) from the fuel cell stack 20.

The controller 70 is a computer system including a CPU, an ROM, an RAM, and an input/output interface and controls each unit in the fuel cell system 10. For example, upon receiving an activation signal output from an ignition switch (not shown), the controller 70 starts an operation of the fuel cell system 10 and obtains required power of the entire system based on, e.g., an accelerator position signal output from an accelerator sensor (not shown) or a vehicle speed signal output from a vehicle speed sensor (not shown). The required power of the entire system is a sum value of vehicle traveling power and auxiliary machine power.

The auxiliary machine power includes, e.g., power consumed by in-vehicle auxiliary machines (the humidifier, the air compressor, the hydrogen pump, a coolant circulating pump, and others), power consumed by devices required for traveling of the vehicle (a transmission, a wheel control device, a steering gear, a suspension device, and others), power consumed by devices arranged in a passengers' space of the vehicle (an air conditioner, a lighting equipment, an audio device, and others), and others.

Additionally, the controller 70 determines distribution of output power of the fuel cell stack 20 and the battery 62, adjusts a number of revolutions of the air compressor 42 or a valve position of the injector 34 in such a manner that electric power generation of the fuel cell stack 20 coincides with target power, adjusts a reactive gas supply quantity with respect to the fuel cell stack 20, and controls the DC/DC converter 61 to adjust an output voltage from the fuel cell stack 20, thereby controlling operating points (an output voltage and an output current) of the fuel cell stack 20. Further, controller 70 outputs each alternating-current voltage instruction value of a U phase, a V phase, or a W phase to the traction inverter 63 as a switching instruction so that a target vehicle speed corresponding to an accelerator opening degree can be obtained, thereby controlling an output torque and a number of revolutions of the traction motor 64.

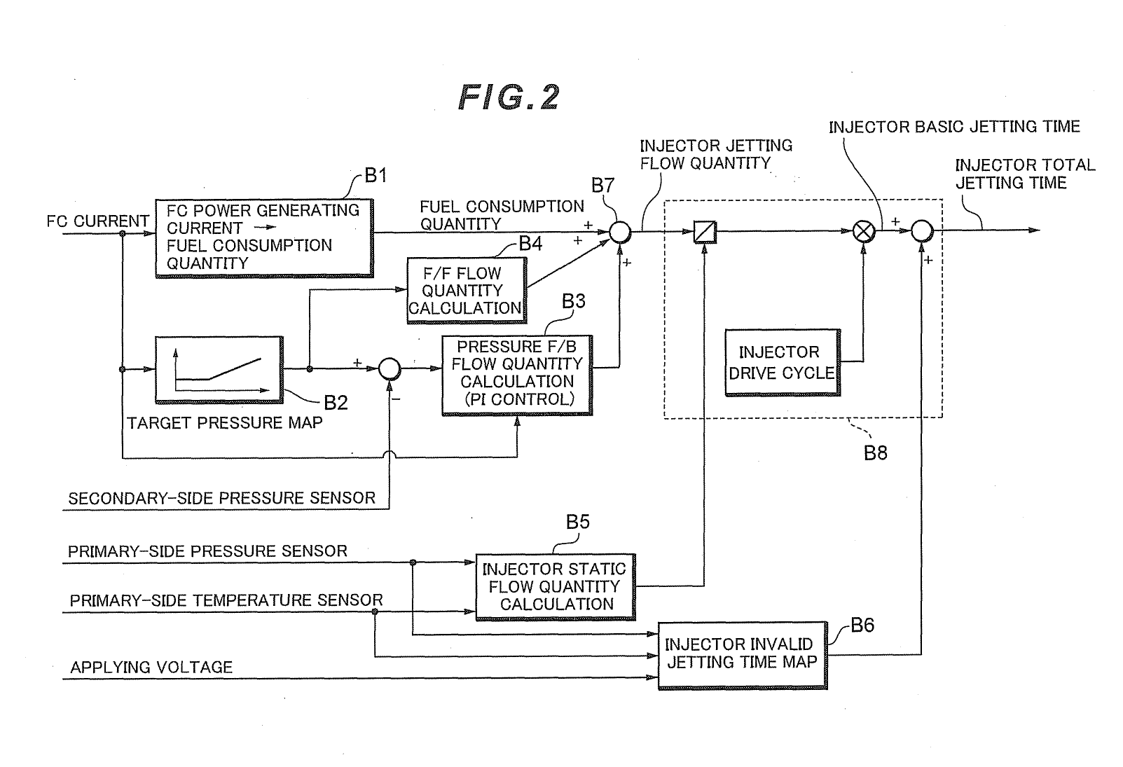

FIG. 2 shows a functional block concerning injector control.

The controller 70 calculates a quantity of a fuel gas consumed by the fuel cell stack 20 (which will be referred to as a “fuel consumption quantity” hereinafter) based on an operating state of the fuel cell stack 20 (e.g., an output current of the fuel cell stack 20 detected by the current sensor 84) (a fuel consumption quantity calculating function: B1). In this embodiment, a predetermined arithmetic expression representing a relationship between an output current value and a fuel consumption quantity of the fuel cell stack 20 is used to calculate and update a fuel consumption quantity in accordance with each arithmetic cycle of the controller 70.

The controller 70 calculates a target pressure value of the fuel gas at a downstream position of the injector 64 (a target gas supply pressure for the fuel cell stack 20) based on an operating state of the fuel cell stack 20 (a current value at the time of power generation of the fuel cell stack 20 detected by the current sensor 84) (a target pressure value calculating function: B2). In this embodiment, map data representing a relationship between a current value of the fuel cell stack 20 and a target pressure value is used to calculate and update a target pressure value at a position where the secondary-side pressure sensor 82 is arranged (a pressure adjusting position as a position where pressure adjustment is requested) in accordance with each arithmetic cycle of the controller 70.

The controller 70 calculates a feedback correction flow quantity based on a deviation of the pressure value (a detected pressure value) at the downstream position (a pressure adjustment position) of the injector 34 detected by the secondary-side pressure sensor 82 from the calculated target pressure value (a feedback correction flow quantity calculating function: B3). The feedback correction flow quantity is a fuel gas flow quantity that is added to the fuel consumption quantity in order to reduce a deviation of the detected pressure value from the target pressure value (a pressure difference reducing correction flow quantity). In this embodiment, a PI type feedback control rule is used to calculate and update a feedback correction flow quantity in accordance with each arithmetic cycle of the controller 70.

The feedback correction flow quantity calculating function B3 multiplies a deviation (e) of an actual flow quantity of the fuel gas from a target value by a proportional gain (K_{P}) to calculate a proportional feedback correction flow quantity (a proportional: P=K_{P}×e), multiplies a time integration value of the deviation (∫(e)dt) by an integration gain (K_{I}) to calculate an integral feedback correction flow quantity (an integral term: I=K_{I}×∫(e)dt), and calculates a feedback correction flow quantity including a value obtained by adding these calculated values.

The feedback correction flow quantity calculating function B3 functions as a feedback control apparatus that performs feedback control over supply of the fuel gas to the fuel cell stack 20 from the injector 34, and also functions as an arithmetic control apparatus that changes an update arithmetic operation of the integral term in accordance with a deviation of an actual flow quantity from a target value of the fuel gas.

The controller 70 calculates a feed forward correction flow quantity associated with a deviation of a currently calculated target pressure value from a previously calculated target pressure value (a feed forward correction flow quantity calculating function: B4). The feed forward correction flow quantity is a quantity corresponding to a fluctuation in the fuel gas flow quantity due to a fluctuation in a target pressure value (a pressure different associated correction flow quantity). In this embodiment, a predetermined arithmetic expression representing a relationship between a deviation from the target pressure value and the feed forward correction flow quantity is used to calculate and update the feed forward correction flow quantity in accordance with each arithmetic cycle of the controller 70.

The controller 70 calculates a static flow quantity on the upstream side of the injector 34 based on a gas state on the upstream side of the injector 34 (a pressure of the fuel gas detected by the primary-side pressure sensor 81 and a temperature of the fuel gas detected by the primary-side temperature sensor 83) (a static flow quantity calculating function: B5). In this embodiment, a predetermined arithmetic expression representing a relationship between a pressure, a temperature, and a static flow quantity of the fuel gas on the upstream side of the injector 34 is used to calculate and update a static flow quantity in accordance with each arithmetic cycle of the controller 70.

The controller 70 calculates an invalid jetting time of the injector 34 based on an upstream-side gas state (a pressure and a temperature of the fuel gas) and an applying voltage of the injector 34 (an invalid jetting time calculating function: B6). Here, the invalid jetting time means a time required to actually start jetting after the injector 34 receives a control signal from the controller 70. In this embodiment, map data representing a relationship between a pressure, a temperature, an applying voltage, and an invalid jetting time of the fuel gas on the upstream side of the injector 34 is used to calculate and update an invalid jetting time in accordance with each arithmetic cycle of the controller 70.

The controller 70 adds the fuel consumption quantity, the feedback correction flow quantity, and the feed forward correction flow quantity to calculate a jetting flow quantity of the injector 34 (a jetting flow quantity calculating function: B7). Further, the controller multiplies a value obtained by dividing a jetting flow quantity of the injector by a static flow quantity by a drive cycle of the injector 34 to calculate a basic jetting time of the injector 34, and also adds this basic jetting time to the invalid jetting time to calculate a total jetting time of the injector 34 (a total jetting time calculating function: B8). Here, the drive cycle means a cycle of a step-like (on/off) waveform representing an opening/closing state of the jet orifice of the injector 34. In this embodiment, the controller 70 sets the drive cycle to a fixed value.

The controller 70 outputs to the injector 34 a jetting instruction required to realize a total jetting time of the injector 34 calculated through the above-explained procedure to control a gas jetting time and a gas jetting timing of the injector 34, thereby adjusting a flow quantity and a pressure of the fuel gas supplied to the fuel cell stack 20.

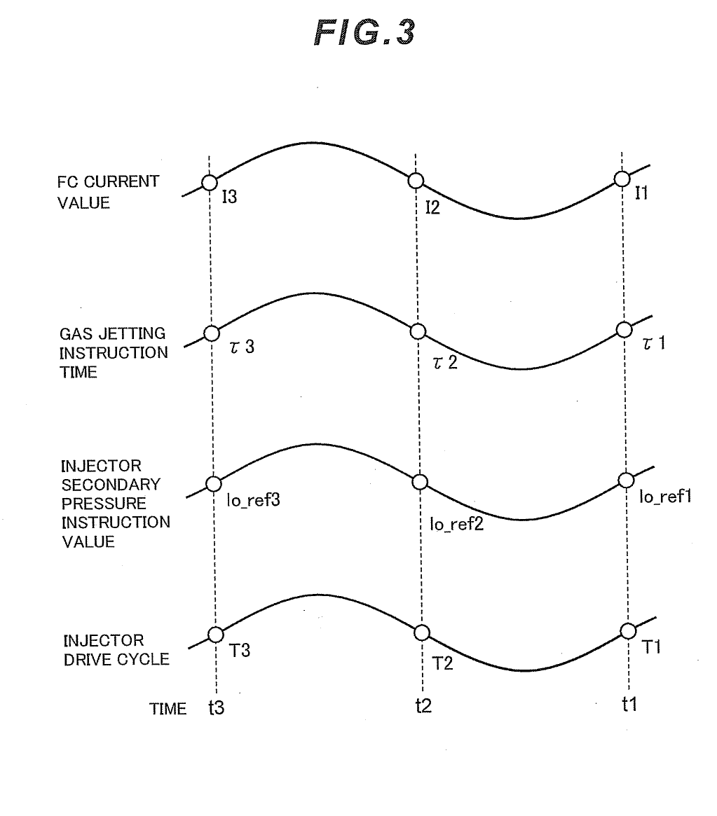

A timing for allowing the update arithmetic operation of the integral term of the feedback correction flow quantity concerning injector control will now be described with reference to FIG. 3.

This drawing shows a timing chart of FC current values, gas jetting instruction times, injector secondary pressure instruction values, and injector drive cycles. Each of times t3 to t1 represents an injector jetting timing. Each of FC current values 13 to 11 is a current value detected by the current sensor 84 at each injector jetting timing. Each of gas jetting instruction times T3 to T1 represents a time at which the fuel gas is emitted from the injector 34 at each injector jetting timing. Each of injector secondary pressure instruction values lo_ref3 to lo_ref1 is a target value of an injector secondary pressure at each injector jetting timing. The injector drive cycle represents a gas jetting interval of the injector 34. For example, an injector drive cycle T3 represents a time interval between the time t3 and the time t2, and the gas jetting instruction time τ3 represents a time at which the gas is emitted during the injector drive cycle T3. Likewise, the injector drive cycle T2 represents a time interval between the time t2 and the time t1, and the gas jetting instruction time τ2 represents a time at which the gas is emitted during the injector drive cycle T2.

In this embodiment, the update arithmetic operation of the integral term based on the feedback correction flow quantity calculating function B3 is allowed under a condition that all the following conditions (1) to (3) are satisfied.

(1) The injector 34 is stable and the gas is emitted therefrom.

(2) A variation of the injector secondary pressure instruction value with time is less than a predetermined value.

(3) A variation of the FC current with time is less than a predetermined threshold value.

On the other hand, when any one of the conditions (1) to (3) is not satisfied, the update arithmetic operation of the integral term based on the feedback correction flow quantity calculating function B3 is inhibited. Here, to achieve the condition (1), each injector jetting time must not be zero, i.e., Expression (1A) must be attained.

τ1>0 and τ2>0 and τ3>0 (1A)

When Expression (1A) is attained, an injector jetting stabilization flag is turned on. On the other hand, when any one of τ1, τ2, and τ3 is zero, i.e., when Expression (1A) is not attained, the injector jetting stabilization flag is turned off.

To achieve the condition (2), a variation of the injector secondary pressure instruction value with time must be less than a predetermined threshold value, i.e., the following Expressions (2A) and (2B) must be all attained.

Δlo_{—}ref3=|lo_{—}ref3−lo_{—}ref2|/T3≦20 Pa/s (2A)

Δlo_{—}ref2=|lo_{—}ref2−lo_{—}ref1|T3≦20 Pa/s (2B)

When Expressions (2A) to (2B) are all attained, the injector secondary pressure stabilization flag is turned on. On the other hand, when any one of Expressions (2A) to (2B) is not attained, the injector secondary pressure stabilization flag is turned off.

To achieve the condition (3), a variation of the FC current with time must be less than a predetermined threshold value, i.e., the following Expressions (3A) and (3B) must be all attained.

ΔI3=|I3−I2|/T3≦30 mA/s (3A)

ΔI2=|I2−I1|/T2≦30 mA/s (3B)

When Expressions (3A) and (3B) are all attained, an FC current stabilization flag is turned on. On the other hand, when any one of Expressions (3A) and (3B) is not attained, the FC current stabilization flag is turned off.

When the injector jetting stabilization flag, the injector secondary pressure stabilization flag, and the FC current stabilization flag are all turned on, an integration allowance flag is turned on, and the update arithmetic operation of the integral term based on the feedback correction current flow quantity calculating function B3 is allowed. On the other hand, when any one of the injector jetting stabilization flag, the injector secondary pressure stabilization flag, and the FC current stabilization flag is turned off, the integration allowance flag is turned off, and the update arithmetic operation of the integral term based on the feedback correction flow quantity calculating function B3 is inhibited.

As explained above, when the update arithmetic operation of the integral term based on the feedback correction flow quantity calculating function B3 is allowed under the condition that the conditions (1) to (3) are all satisfied, it is possible to suppress an overshoot of the injector secondary pressure caused due to execution of the update arithmetic operation of the integral term while regarding a deviation of the injector secondary pressure from the injector secondary pressure instruction value as a steady-state deviation.

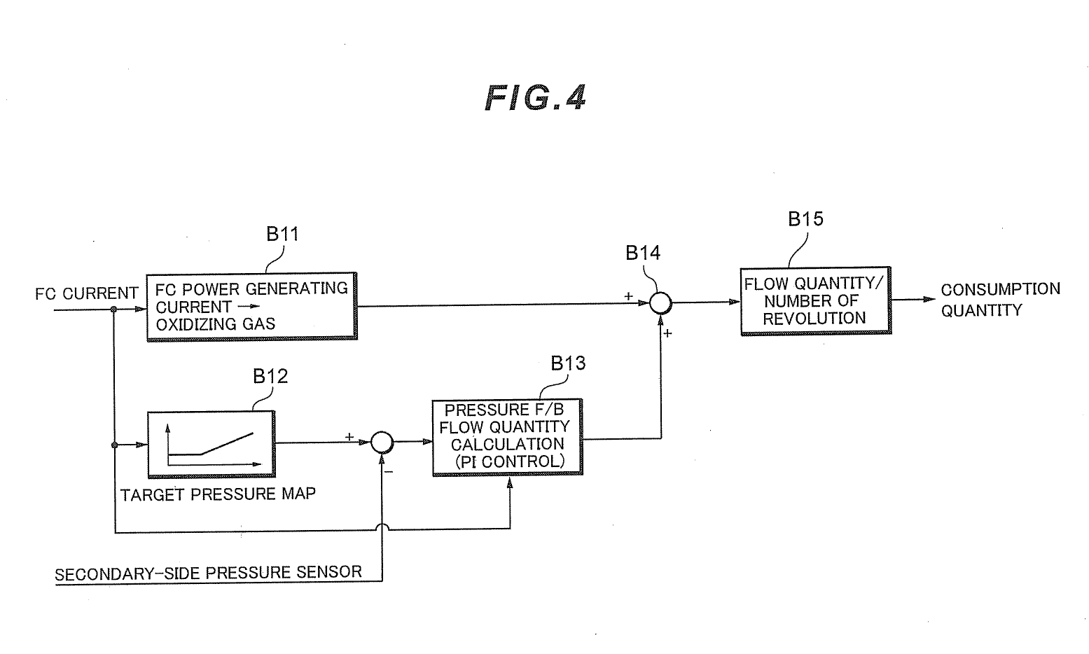

FIG. 4 shows a functional block concerning air compressor control.

The controller 70 calculates a quantity of the oxidizing gas consumed by the fuel cell stack 20 (which will be referred to as an “oxidizing gas consumption quantity” hereinafter) based on an operating state of the fuel cell stack 20 (e.g., an output current of the fuel cell stack 20 detected by the current sensor 84) (an oxidizing gas consumption quantity calculating function: B11). In this embodiment, a predetermined arithmetic expression representing a relationship between an output current value and an oxidizing gas consumption quantity of the fuel cell stack 20 is used to calculate and update an oxidizing gas consumption quantity in accordance with each arithmetic cycle of the controller 70.

The controller 70 calculates a target pressure value of the oxidizing gas at a downstream position of the air compressor 42 (a target gas supply pressure with respect to the fuel cell stack 20) based on an operating state of the fuel cell stack 20 (a current value at the time of power generation of the fuel cell stack 20 detected by the current sensor 84) (a target pressure value calculating function: B12). In this embodiment, map data representing a relationship between a current value and a target pressure value of the fuel cell stack 20 is used to calculate and update a target pressure value at a position where the secondary-side pressure sensor 85 is arranged (a pressure adjustment position as a position where pressure adjustment is requested) in accordance with each arithmetic cycle of the controller 70.

The controller 70 calculates a feedback correction flow quantity based on a deviation of a pressure value (a detected pressure value) at a downstream position (a pressure adjustment position) of the air compressor 42 detected by the secondary-side pressure sensor 85 from the calculated target pressure value (a feedback correction flow quantity calculating function: B13). The feedback correction flow quantity is an oxidizing gas flow quantity (a pressure difference reducing correction flow quantity) that is added to the oxidizing gas consumption quantity in order to reduce the deviation of the detected pressure value from the target pressure value. In this embodiment, the PI type feedback control rule is used to calculate and update the feedback correction flow quantity in accordance with each arithmetic cycle of the controller 70.

The feedback correction flow quantity calculating function B13 multiplies a deviation (e) of an actual flow quantity of the oxidizing gas from a target value of the same by a proportional gain (K_{P}) to calculate a proportional feedback correction flow quantity (a proportional: P=K_{P}×e), multiplies a time integration value of the deviation (∫(e)dt) by an integration gain (K_{I}) to calculate an integral feedback correction flow quantity (an integral term: I=K_{I}×∫(e)dt)), and thereby calculates a feedback correction flow quantity including a value obtained by adding these calculated values.

The feedback correction flow quantity calculating function B13 functions as a feedback control apparatus that performs feedback control over supply of the oxidizing gas to the fuel cell stack 20 from the air compressor 42 and also functions as an arithmetic control apparatus that changes the update arithmetic operation of the integral term in accordance with a deviation of an actual flow quantity from a target value of the oxidizing gas.

The controller 70 adds the oxidizing gas consumption quantity to the feedback correction flow quantity to calculate a flow quantity of the oxidizing gas output from the air compressor 42 (an oxidizing gas flow quantity calculating function: B14). Further, the controller 70 converts the oxidizing gas flow quantity calculated by the oxidizing gas flow quantity calculating function B14 into a number of revolutions of the air compressor 42 (a gas flow quantity/revolution converting function: B15) to output a revolution instruction value to the air compressor 42.

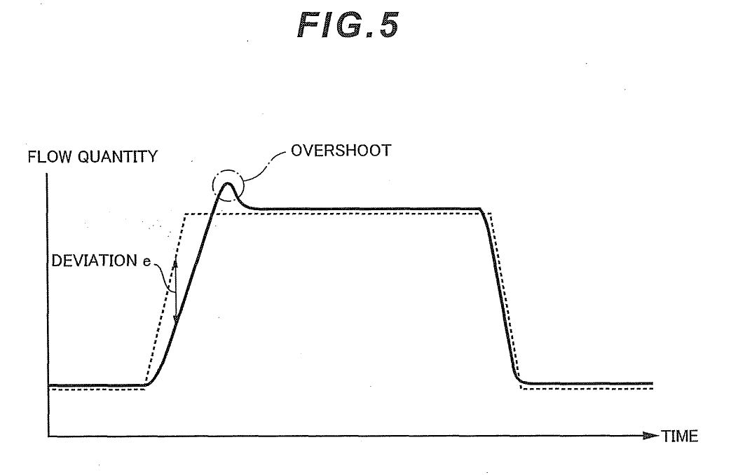

A timing at which the update arithmetic operation of the integral term of the feedback correction flow quantity concerning air compressor control is allowed will now be described with reference to FIG. 5.

In this embodiment, when a value of the proportional P=K_{P}×e concerning air compressor control exceeds a predetermined threshold value, a value of the proportional gain K_{I} of the integral term I=K_{I}×∫(e)dt is reduced. When a value of the proportional P exceeds the predetermined threshold value, an actual measurement value (a solid line) of the oxidizing gas flow quantity cannot catch up with a target value (a doted line) of the same, and the deviation of these values is increased. In such a case, when a value of the proportional gain K_{I} is changed to a value that is approximately 1/20 to 1/10 of a regular value (a value of the proportional gain K_{I} in an operating state where a load hardly fluctuates), an integration value of the integral term I in a transient period can be reduced even if the deviation e is regarded as a steady-state deviation to execute the update arithmetic operation of the integral term I. Therefore, it is possible to suppress an overshoot of the oxidizing gas flow quantity when the target values is stabilized at a fixed value (FIG. 5 shows an example where air compressor control concerning the conventional example brings about an overshoot for the same of convenience).

However, when a load of the fuel cell stack 20 is again, e.g., stabilized and a value of the proportional P thereby becomes lower than the predetermined threshold value, a value of the proportional gain K_{I} of the integral term I must be restored to a value before change. When restoring a value of the proportional gain K_{I} to a value before change, it is desirable to gradually increase the value of the proportional gain K_{I}to be restored to the value before change rather than directly restore to the value before change.

It is to be noted that a target of proportional-plus-integral control in the feedback correction flow quantity calculating function B13 is consistently the oxidizing gas flow quantity and it is not a number of revolutions of the air compressor 42. When there is a small error when converting the oxidizing gas flow quantity into the number of revolutions of the air compressor 42, this small error is built up to appear as a steady-state error. To reduce the steady-state error based on feedback control, continuing the upgrade arithmetic operation of the integral term I irrespective of an operating state is desirable. That is, even when a load of the fuel cell stack 20 transiently fluctuates (when a value of the proportional P exceeds a predetermined threshold value), it is desirable to execute the upgrade arithmetic operation with respect to the integral term I without setting a value of the proportional gain K_{I} to zero.

The examples described through the embodiment according to the present invention can be appropriately combined, changed, or modified in accordance with an application, and the present invention is not restricted to the description of the foregoing embodiment. For example, the fuel cell system 10 may be mounted as an electric power source for various kinds of mobile objects. Furthermore, the fuel cell system 10 according to this embodiment may be operated as a power generating unit (a stationary electric generating system) in, e.g., houses or buildings.

### INDUSTRIAL APPLICABILITY

According to the present invention, erroneous integration of a deviation of an actual flow quantity from a target value of a reactive gas when a fluctuation in load of a fuel cell is large can be suppressed by changing an upgrade arithmetic operation of an integral term based on the deviation of the actual flow quantity from the target value of the reactive gas supplied to the fuel cell, thereby suppressing an overshoot of a reactive gas supply flow quantity.

1. A fuel cell system comprising:
a reactive gas supplying apparatus which supplies a reactive gas to a fuel cell;
a feedback control apparatus which performs feedback control with respect to the reactive gas supplying apparatus based on a proportional obtained by multiplying a deviation of an actual flow quantity from a target value of a reactive gas supplied to the fuel cell from the reactive gas supplying apparatus by a proportional gain and an integral term obtained by multiplying the deviation by an integration gain to perform time integration in such a manner that the actual flow quantity coincides with the target value; and
an arithmetic control apparatus which changes an update arithmetic operation of the integral term in accordance with a value of the deviation.

2. The fuel cell system according to claim 1, wherein the reactive gas supplying apparatus is an injector which supplies a fuel gas to the fuel cell, and the arithmetic control apparatus inhibits the update arithmetic operation of the integral term when the deviation of the actual flow quantity from the target value of the fuel gas is equal to or above a predetermined threshold value.

3. The fuel cell system according to claim 1, wherein the reactive gas supplying apparatus is an air compressor which supplies an oxidizing gas to the fuel cell, and the arithmetic control apparatus changes the integration gain to a smaller value when the deviation of the actual flow quantity from the target value of the oxidizing gas is equal to or above a predetermined threshold value.

4. The fuel cell system according to claim 1, comprising an injector which supplies a fuel gas to the fuel cell and an air compressor which supplies an oxidizing gas to the fuel cell as the reactive gas supplying apparatus,
wherein the feedback control apparatus performs feedback control with respect to fuel gas supply using the injector and oxidizing gas supply using the air compressor.
